(19) United States
(12) Patent Application Publication
(10) Pub. No.: US 2005/0125466 A1
(43) Pub. Date: Jun. 9, 2005

(54) Information processing unit, information processing system, control program, computer-readable storage medium, and information processing method

(75) Inventor: Kunihiko Tsujimoto, Osaka-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 10/992,190

(22) Filed: Nov. 18, 2004

(30) Foreign Application Priority Data
Nov. 20, 2003 (JP) 2003-390192

(51) Int. Cl. G06F 17/30

(52) U.S. Cl. 707/204

(57) ABSTRACT

An account comparison section 115 of a management server 100 compares sets of account information which are sets of account information of a terminal device 1a and are respectively added to sets of address data including the account information, with sets of account information of the terminal device 1b which are stored in an account management table 120. In accordance with the comparison, a set of address data having added thereto a set of account information that the terminal device 1a and the terminal device 1b have in common is extracted (Steps S25 and S26). Then, the extracted set of address data is stored in an address data storage section 11b of the terminal device 1b (Steps S27 through S29).

This Nonprovisional application claims priority under 35 U.S.C. § 119(a) on Patent Application No. 2003/390192 filed in Japan on Nov. 20, 2003, the entire contents of which are hereby incorporated by reference.

### FIELD OF THE INVENTION

The present invention relates to an information processing unit, an information processing system, a control program, a computer-readable storage medium, and an information processing method all of which, when predetermined information (e.g. address data) is updated by any of a plurality of terminal devices connected over a network, reflects updates with respect to another terminal device. Particularly, the present invention relates to an information processing unit, an information processing system, a control program, a computer-readable storage medium, and an information processing method all of which reflects the predetermined information only if the reflection is appropriate, thereby realizing prevention of an inadvertent data leakage.

### BACKGROUND OF THE INVENTION

For data transmissions between terminal devices on a network, it is convenient that one terminal device that is a data-transmission-end stores, in advance, a collection of addresses (e.g. facsimile address, network address, and/or e-mail address) that identify data-reception-end terminal devices to which the data-transmission-end terminal device wants to transmit data, and the data-transmission-end terminal device uses this collection of addresses for transmissions. The collection of addresses is generally termed “address book”, and a technique for performing data transmissions with respect to devices corresponding to addresses stored in the address book is well known.

The technique disclosed in patent document 1 (Japanese Laid-Open Patent Application No. 2001/177540 (Tokukai 2001-177540); published on Jun. 29, 2001) is a technique that when an address book with which one of the terminal devices on a network is provided is updated, the updates are automatically reflected to address books with which other terminal devices on the network are provided, via an address management server which can communicate with the terminal devices on the network. With this technique, when an address book of one terminal device is updated, the updates are reflected to address books with which all the terminal devices on the network are provided. Therefore, it is possible to obtain the effect of eliminating the need for a complicated task such as updating of address books for each terminal device.

In recent years, especially in companies and other organizations, there are increasing tendencies to enhance security regarding the use of terminal devices for prevention of information leaks and unauthorized use of the terminal devices. Examples of the methods often used for such security enhancement include a method, for user's login to a network by operation of a terminal device, of requesting the user to enter an ID, password, and the like into a screen which is provided on the terminal device, so as to check an access right to the network or the terminal device (account information).

That is, if account information of a user is not registered in a terminal device that the user wants to access, the user cannot use the terminal device. In some cases, as to address data (e.g. recipient's name, e-mail address, telephone number, and the like) of a terminal device as a destination, used for transmission of information such as image data and text data, a further security enhancement is realized by registering the address data associated with the foregoing account information in a terminal device, a server which manages the terminal device, or the like.

### SUMMARY OF THE INVENTION

However, in the case of the technique disclosed in the patent document 1, when one terminal device updates its address book, the updates are reflected to address books of all the terminal devices on the network. Therefore, in the case where the address book serves as access right information (account information) that is information about address data of the user who has been permitted for access to the terminal device, account information of a user other than a user whose account information is registered is also registered in an address book of a terminal device which particularly enhances its security, such as a server or the like which only an administrator can operate (i.e. a server or the like in which only sets of account information corresponding to a limited number of people are registered). This results in the problem of information leaks. Moreover, since an address data of a user other than the user whose account information is registered is also registered in the address book, there is also the problem of a wasted storage space in the terminal device.

The present invention has achieved in view of the above problems, and its object of the present invention is to provide an information processing unit, information processing system, control program, computer-readable storage medium, and information processing method all of which, when one of the terminal devices on a network updates sets of predetermined information (e.g. address data), can reflect to other terminal devices on the network only the set of predetermined information which is managed by a user who has an access right to the terminal device.

To attain the above object, an information processing un it of the present invention is an information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device,
the sets of predetermined information stored in each of the terminal devices, being sets of information respectively having added thereto sets of access right information in whole or in part pertaining to an access right with respect to each of the terminal devices,
the information processing unit comprising:
(a) terminal access right information storage means which stores the sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

According to this arrangement, when one of the terminal devices on the network updates its sets of predetermined information (e.g. address data), the terminal access right information extraction means compares sets of access right information in whole or in part respectively added to the sets of predetermined information, with sets of access right information in whole or in part about other terminal device, stored in the terminal access right information storage means, so as to extract a set of predetermined information having added thereto a set of access right information that both of the terminal devices have in common. Therefore, only such information is reflected with respect to other terminal device on the network.

That is, a set of predetermined information managed by a user who does not have the access right information is not extracted by the terminal access right information extraction means, and is not therefore reflected with respect to other terminal device on the network.

This prevents information of a user who does not have access right information (e.g. account information) to other terminal device from being unnecessarily registered in a plurality of terminal devices. As a result of this, the problem of information leaks is solved. Furthermore, only predetermined information of a user who has registered access right information is registered, so that the problem of a wasted storage space in the terminal device is solved.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a configuration of an information processing system according to one embodiment of the present invention.

FIG. 2 is a flowchart illustrating a process of updating address data including account information, implemented by a control section 18a of the terminal device 1a in the information processing system illustrated in FIG. 1.

FIG. 3 is a flowchart illustrating a process implemented in the information processing system illustrated in FIG. 1.

FIG. 4 is a diagram illustrating a list of sets of address data registered in the terminal device 1a in the information processing system illustrated in FIG. 1.

FIG. 5 is a diagram illustrating lists of sets of account information registered respectively in the terminal device 1a and a terminal device 1b in the information processing system illustrated in FIG. 1.

FIG. 6 is a diagram illustrating a list of sets of address data registered in the terminal device 1b in the information processing system of FIG. 1.

FIG. 7 is a flowchart illustrating a process, implemented by a management server 100, for reflecting address data updated by the terminal device 1a in the information processing system of FIG. 1, with respect to the terminal device 1b.

FIG. 8 is a flowchart illustrating a process implemented in the information processing system illustrated in FIG. 1 when new account information is registered in the terminal device 1b in the information processing system illustrated in FIG. 1.

FIG. 9 is a diagram illustrating address data newly registered in the terminal device 1b in the information processing system illustrated in FIG. 1.

FIG. 10 is a block diagram illustrating a configuration of an information processing system according to another embodiment of the present invention.

FIG. 11 is a flowchart illustrating a process implemented in the information processing system illustrated in FIG. 10.

### DESCRIPTION OF THE EMBODIMENTS

An embodiment of the present invention will be described below with reference to the accompanying drawings. Note that, in the following embodiment, an example of predetermined information is address data, but it is not limited to the address data. The present invention can be also applied even when the predetermined information is data such as image data, text data, or the like data having an access right added thereto.

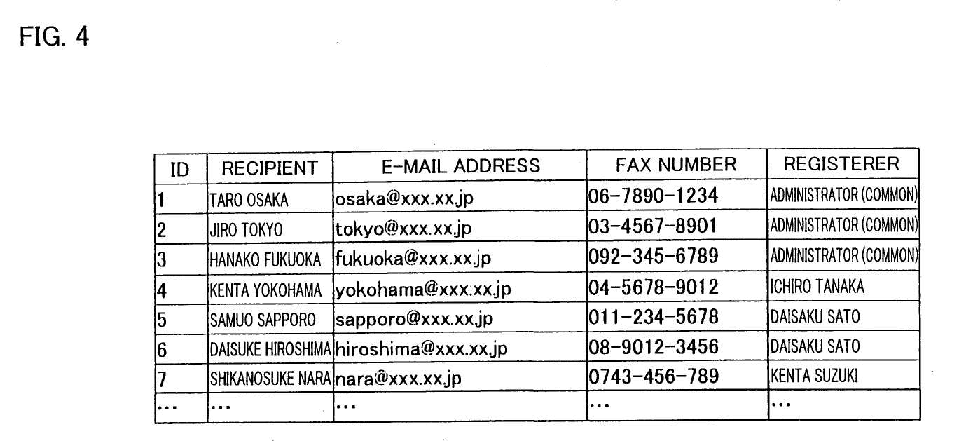

First, address data to be updated that is used in the present embodiment will be simply described with reference to FIG. 4. The address data of the present embodiment, as with a normal address data, includes a name, an e-mail address, a facsimile number, information about a person who has updated or registered address data, i.e. information about a user having account information with respect to a terminal device (registerer information; an example of access right information in whole or in part of the present invention). If the account information is stored only in this area, this is the whole of account information. This registerer information has the following feature.

Address data registered by an administrator has “administrator (common)” as the registerer information. All users that have account information as a right to access a terminal device can use the address data registered by the administrator. Meanwhile, address data registered by other user who is not the administrator has a name of a user who has registered the address data, like “Ichiro Tanaka” and “Daisaku Sato”, as the registerer information. That is, in this case, address data can be used only by a user himself/herself who has registered the address data. As a matter of course, even if a person who registers address data is the administrator, the administrator can make a registration as an individual user, on a list of address data.

For example, sets of address data for IDs 1 through 3 each has “administrator (common)” as the name of a registerer, so that they can be used by all users that have accounts of the terminal device 1a. Meanwhile, sets of address data for IDs 4 through 7 each has the name of an individual user as the name of a registerer, so that they can be used only by their respective users themselves who have registered the sets of address data. For example, address data for the ID 4 has been registered by “Ichiro Tanaka” who is an administrator, as an individual user rather than the administrator. In this case, instead of other user, the administrator can register address data of the other user. For example, as address data for the ID 7, it is possible to set as if “Kenta Suzuki” has registered address data for the ID 7 although the administrator has actually registered it.

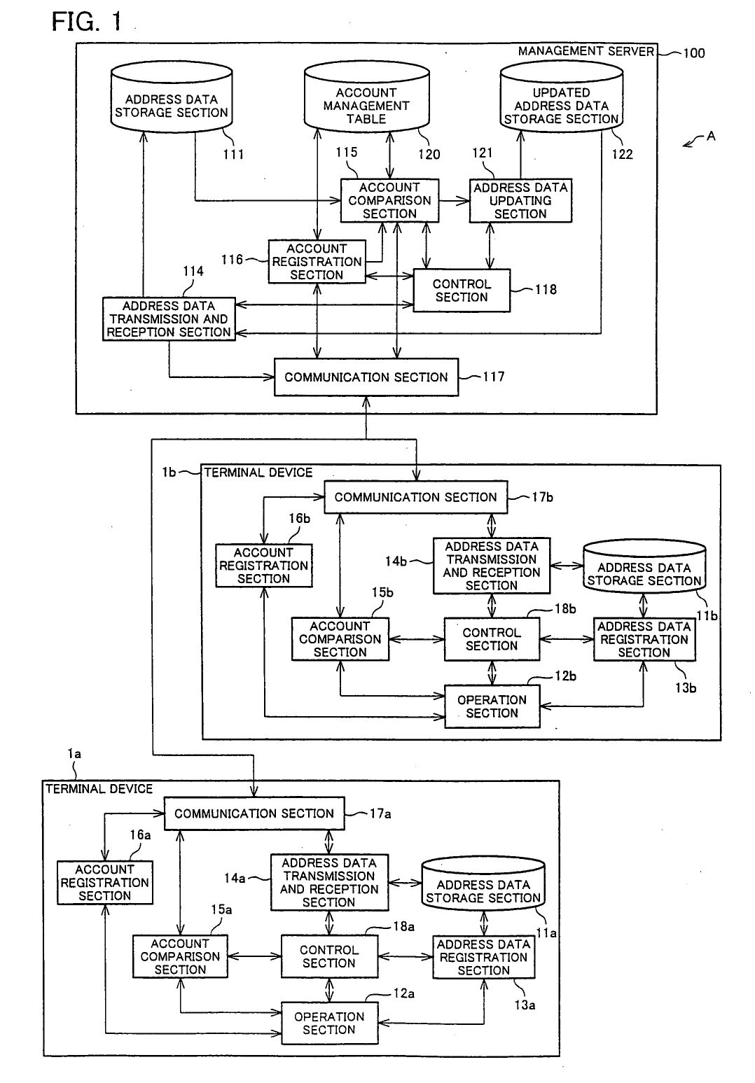

The following will describe an information processing system A according to one embodiment of the present invention with reference to FIG. 1.

The information processing system A mainly includes a plurality of terminal devices 1 (1a, 1b, . . . ) and a management server 100 (an example of an information processing unit of the present invention). The terminal devices and the management server are connected to each other over a network such as Internet or LAN. Note that, a communication interface may be anything, such as USB, parallel cable, serial cable, or the like, provided that the devices are connected to each other in such a manner that data transmission/reception can be made therebetween. Further, the terminal devices 1 include address data storage sections 11a, 11b, . . . (an example of predetermined information storage means of the present invention, details of which will be described later), respectively. The address data storage sections 11a, 11b, . . . each stores sets of address data of the respective terminal devices 1, and the management server 100 collectively manages sets of account information of the respective terminal devices 1, as will be described later.

Note that, the present invention allows any of the terminal devices to update its address data. However, only updating of the address data by the terminal devices 1a and 1b will be described here.

The terminal device 1a and the terminal device 1b connected over the network to the management server 100 which will be described later are first described below. Note that, an internal structure of the terminal device 1a is the same as that of the terminal device 1b. Therefore, only the internal structure of the terminal device 1a is described here, and description of the internal structure of the terminal device 1b is omitted.

The terminal device 1a according to the present embodiment is a device having the function of communications such as facsimile transmission, e-mail transmission, and FTP transmission. Examples of the terminal device 1a include a copier, a printer, a facsimile, and an image forming device realized as a multifunction device that combines the functions of a copier, a printer, and a facsimile into a single unit. Further, the terminal device 1a includes the function of transmitting image data through facsimile transmission, e-mail transmission, or FTP transmission, the function of registering, as a recipient's address data, a facsimile number, an e-mail address, and the like, the function of registering a collective group of such address data, and other function.

The terminal device 1a mainly includes: an operation section 12a, such as a touch panel, for an input interface which is composed of an operation panel, an operation button, and others; an address data registration section 13a which registers in the address data storage section 11a address data that has been entered by the operation section 12a; the address data storage section 11a, such as hard disk and flash memory, which stores address data that has been registered in the terminal device 1a; an address data transmission and reception section 14a which transmits and receives address data to and from the management server 11 described later; an account comparison section 15a which inquires the management server 100 about whether account information is valid or not; an account registration section 16a which registers in the management server 100 account information of the user who uses the terminal device 1a; a communication section 17a which communicates address data and account information with the management server 100; and a control section (an example of access right information addition means of the present invention) 18a which controls the above-mentioned blocks.

For the use of the terminal device 1a by the user, the account comparison section 15a verifies account information entered by the operation section 12a against an account management table 120, which will be described later, provided in the management server 100, whereby the user can use the terminal device 1a. Further, updating, new registration, and other operations with respect to address data can be performed through the operation section 12a. Details of these operations will be described later.

Next, the following will describe a main configuration of the management server 100 used for a server that manages and updates account information and address data.

The management server 100 mainly includes: a communication section 117 which communicates address data and account information with the terminal devices 1a, 1b, . . . ; an address data transmission and reception section 114 (an example of extracted information transmission means and received information transmission means of the present invention) which transmits and receives address data to and from the terminal device 1a and others; an address data storage section 111, such as hard disk and flash memory, which temporarily stores address data acquired from the terminal device 1a and others; an account comparison section (an example of terminal access right information extraction means and new access right information determination means of the present invention) 115 which compares sets of account information of the respective terminal device 1a and others; an account registration section 116 which registers sets of new account information of the respective terminal device 1a and others in the account management table 120; an account management table 120 (an example of terminal access right information storage means of the present invention), such as hard disk, flash memory, or RAM, which stores and manages sets of account information of the respective terminal device 1a and others; an address data updating section 121 which updates address data; an updated address data storage section 122, such as hard disk, flash memory, or RAM, which stores an updated address data; and a control section 118 (an example of terminal access right information extraction means and terminal access right information writing means of the present invention) which controls the above-mentioned blocks.

Here, the foregoing account comparison section 115, for the use of the terminal device 1a and others by the user, also compares information entered through the operation section 12a with account information stored in the account management table 120. Note that, sets of account information of the terminal device 1a and others can be registered directly from a screen or the like (not shown) provided on the management server 100.

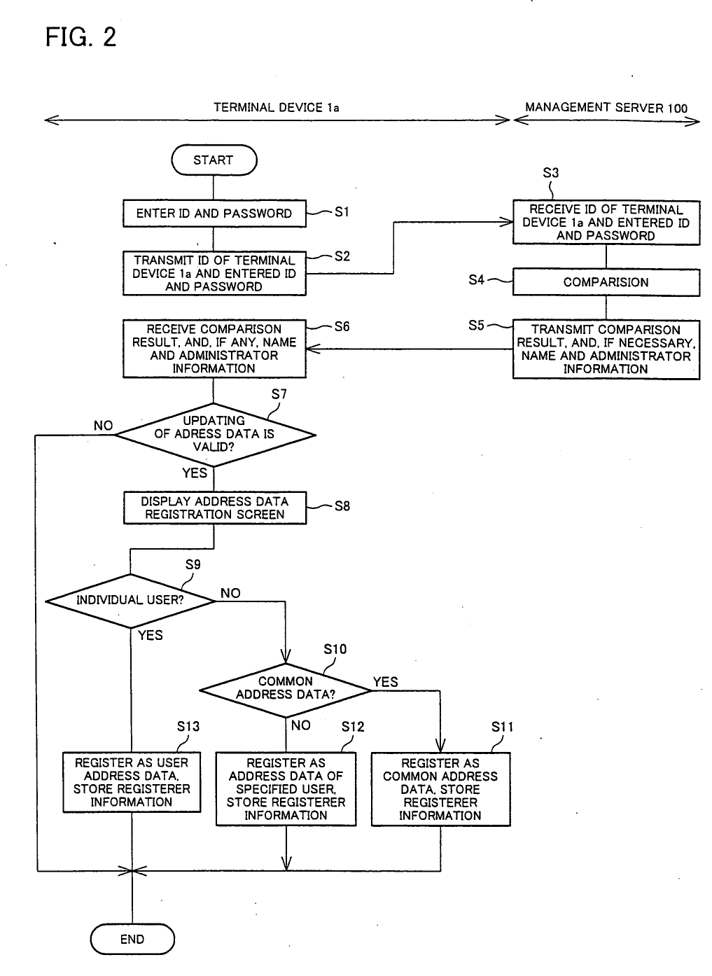

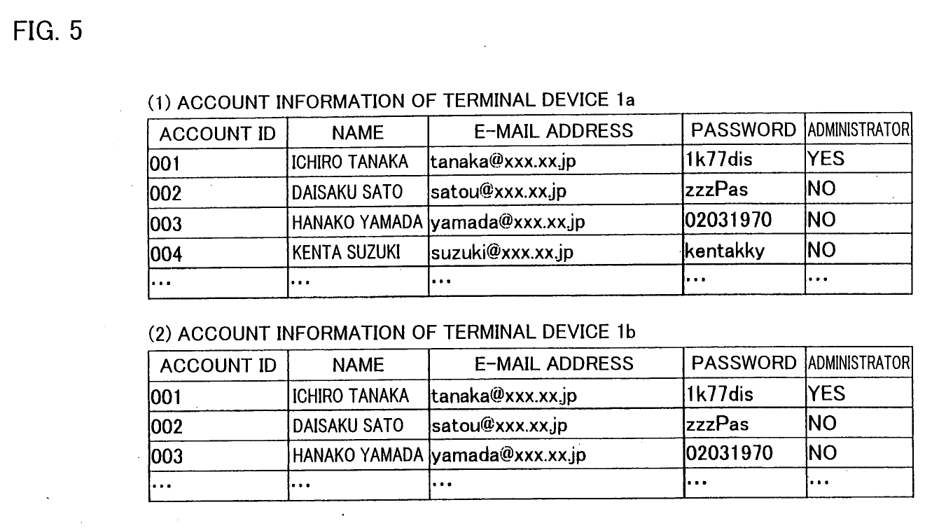

Now, referring to FIGS. 2, 4, and 5, the following will describe a process for updating address data including account information, implemented by the control section 18a of the terminal device 1a. Note that, it is assumed that the account management table 120 in the management server 100 stores in advance sets of account information each including an account ID of a user who can access the terminal device 1a and/or 1b, as illustrated in FIG. 5. Note that, S1, S2, and the like reference numerals given in the following descriptions represent procedures (steps) for the updating process.

For user's implementation of the address data updating process, the user must log in to a program therefor. When this program is started, an account ID and others entry screen for user's login is shown up on the operation section 12a of the terminal device 1a. When the user enters an account ID and password into the entry screen and presses a confirmation button or the like provided on the entry screen (S1), an ID of the terminal device that is used by the user (i.e. ID of the terminal device 1a), the account ID, and the password are transmitted, under the control of the control section 18a, via the communication sections 17a and 117 to the management server 100 (S2).

When the management server 100 receives the ID of the terminal device 1a, the account ID, and the password (S3), the account comparison section 115 compares the ID of the terminal device 1a, account ID, and password all of which have been received from the terminal device 1a with an account ID and password for each terminal device, stored in advance in the account management table 120 (see FIG. 5) (S4).

As illustrated in FIG. 5, the account management table 120 stores, for each terminal device, sets of account information each including an account ID for a user having an access right with respect to the terminal device, a user's name (name) unique to the account ID, an e-mail address of the user, a password corresponding to the account ID, information about whether it is an administrator or not, and others. Here, the account information normally is the account ID and password.

As a result of the comparison procedure in the Step S4; if the received account ID and password for each terminal device do not match an account ID and password included in the account information for the terminal device 1a, illustrated in FIG. 5, i.e. if the received account ID and password for each terminal device are determined as invalid, the user who have entered the received account ID and password is regarded as being not eligible for the use of the terminal device 1a. Then, a data signal (comparison result) indicating that the received account ID and password are invalid is transmitted from the management server 100 to the terminal device 1a.

On the other hand, as a result of the comparison procedure in the Step S4, if the received account ID and password match an account ID and password included in the account information for the terminal device 1a, illustrated in FIG. 5, i.e. if the received account ID and password for each terminal device are determined as valid, the user who have entered the received account ID and password is regarded as being eligible for the use of the terminal device 1a. Then, a data signal (comparison result) indicating that the received account ID and password are valid is transmitted from the management server 100 to the terminal device 1a. In this case, in addition to the data signal, “name” and “administrator” (see FIG. 5), used for the after-mentioned updating of the address data, corresponding to the foregoing account ID and password are transmitted from the management server 100 to the terminal device 1a (S5).

When the terminal device 1a receives the data signal indicating that the account ID and password are valid or invalid (S6), the terminal device 1a determines the result (S7). If the result indicates invalidity of the account ID and password, the user is regarded as not having an access right with respect to the terminal device 1a. Then, this process is ended by displaying on the operation section 12a a screen indicating that the account ID and password are invalid (“NO” in S7).

If it is determined that the account ID and password are valid (“YES” in S7), the user has an access right with respect to the terminal device 1a, so that the control section 18a of the terminal device 1a displays, for example, an address data registration screen on the operation section 12a, for permission of address data entry (S8).

After the address data registration screen is displayed, the user enters information about his/her address data through the screen. Thereafter, when the user pushes an update button or the like, the control section 18a compares the entered user's address data with “administrator” data (FIG. 5) in the data received in the foregoing Step S6, and determines whether the user entering the address data is an administrator or individual user (S9). This procedure of the Step S9 allows the control section 18a to determine whether a user who is going to update address data is an administrator (i.e. “Ichiro Tanaka” in FIG. 5) or other user (user except for “Ichiro Tanaka” in FIG. 5).

If the user is determined as the administrator, the process goes to Step S10. On the other hand, if the user is determined as the individual user, the process goes to Step S13. This procedure of the Step S9 allows the terminal device 1a to separately store a common address data that anyone can use (hereafter referred to as “common address data”) and address data that only an individual user can use (hereinafter referred to as “individual address data”).

Note that, if the user is determined as the individual user, the “name (Ichiro Tanaka in this procedure)” received in the Step S6 may be used as “registerer” illustrated in FIG. 4. Alternatively, the foregoing account ID, password, and others may be added to the address data of FIG. 4.

As described above, if the user is determined as the administrator in the procedure of Step S9 (“NO” in S9), the control section 18a determines whether address data to be updated is the common address data, i.e. address data of the administrator or the individual address data, i.e. address data of the individual user (S10).

If the address data to be updated is the common address data, registerer information is stored as “administrator (common)” in the address data storage section 11a, for example, like sets of address data for the ID 1 through ID 3 in FIG. 4 (S11). On the other hand, if the address data to be updated is the individual address data, registerer information is stored as individual address data of the administrator, “Ichiro Tanaka”, into the address data storage section 11a, like address data for ID 4 in FIG. 4 (S12). In this case, registerer information of the address data is an administrator, “Ichiro Tanaka”.

Here, as described previously, as to the individual address data used by an individual user except for the administrator, the administrator can update it, instead of the user of the individual address data. That is, in the case of the address data for the ID 7 in FIG. 4, for example, its registerer is “Kenta Suzuki”. However, instead of “Kenta Suzuki”, the administrator can perform updating. In this case, the registerer information is the administrator, “Kenta Suzuki”.

Further, in the procedure of the foregoing Step S9, if the user is determined as a user other than the administrator (“NO” in S9), the address data to be updated is updated as individual address data that can be used only by its user. (S13). In this case, registerer information illustrated in FIG. 4 is stored as account information of the user himself/herself by the control section 18a into the address data storage section 11a. Here, if the user is an individual user, the “name” having been received in the foregoing Step S6 may be used as “registerer” illustrated in FIG. 4. Alternatively, the foregoing account ID, password, and others may be added to the address data in FIG. 4.

Note that, a function of performing the foregoing Steps S9 through S13 is an example of a function implemented by the access right information addition means of the present invention.

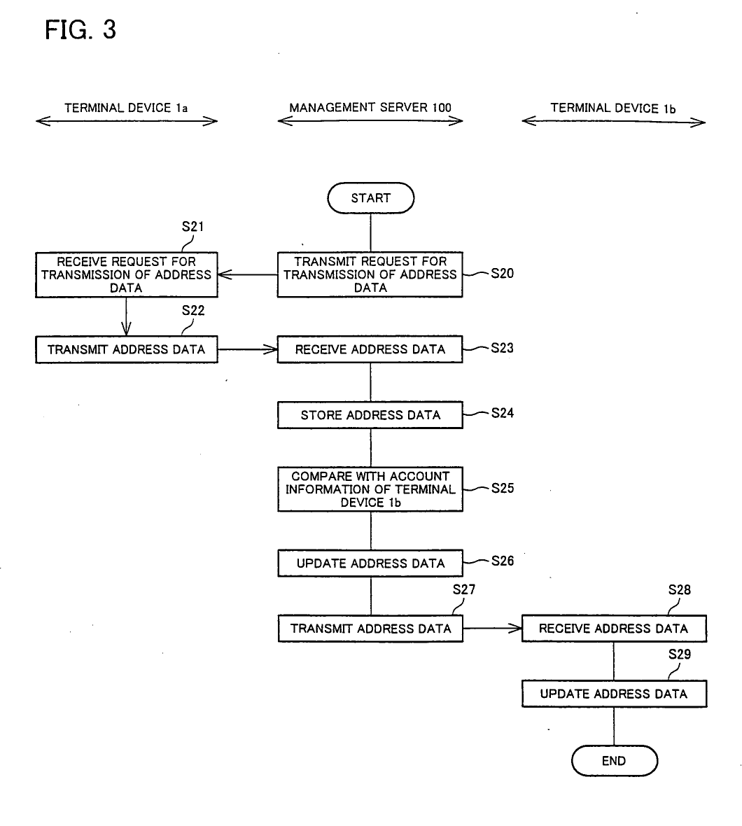

Next, referring to FIGS. 3 through 7, the following will describe a process for, when address data is updated in a terminal device (e.g. terminal deice 1a), reflecting the update with respect to other terminal device (e.g. terminal device 1b). This process is mainly implemented by the control section 118 of the management server 100. Note that, S20, S21, and the like reference numerals given in the following descriptions represent procedures (steps) for this process.

As illustrated in FIG. 3, when, in the management server 100, a manual operation is performed by the administrator or a process for automatic updating of an application is started, a signal for requesting transmission of address data is transmitted from the address data transmission and reception section 114 to the terminal device 1a (S20). As a rule, the request signal for such updating is periodically transmitted to all the terminal devices in sequence.

When the request signal is received by the address data transmission and reception section 14a of the terminal device 1a (S21), the control section 18a causes the address data transmission and reception section 14a to transmit, to the management server 100, the sets of address data (the sets of address data illustrated in FIG. 4) each including account information (e.g. “registerer” in FIG. 4), stored in the address data storage section 11a of the terminal device 1a (S22). These sets of address data are received by the address data transmission and reception section 114 of the management server 100 (S23) and are temporarily stored in the address data storage section 111 (S24).

Thereafter, account information added to the address data stored in the address data storage section 111 is compared with the sets of account information of the terminal device 1a, stored in the account management table 120 illustrated in FIG. 5, so that address data having added thereto account information that the terminal device 1a and the terminal device 1b have in common is extracted. These account information comparison process and address data extraction process are performed by the account comparison section 115 (S25). The extracted address data is stored in the updated address data storage section 122 (S26).

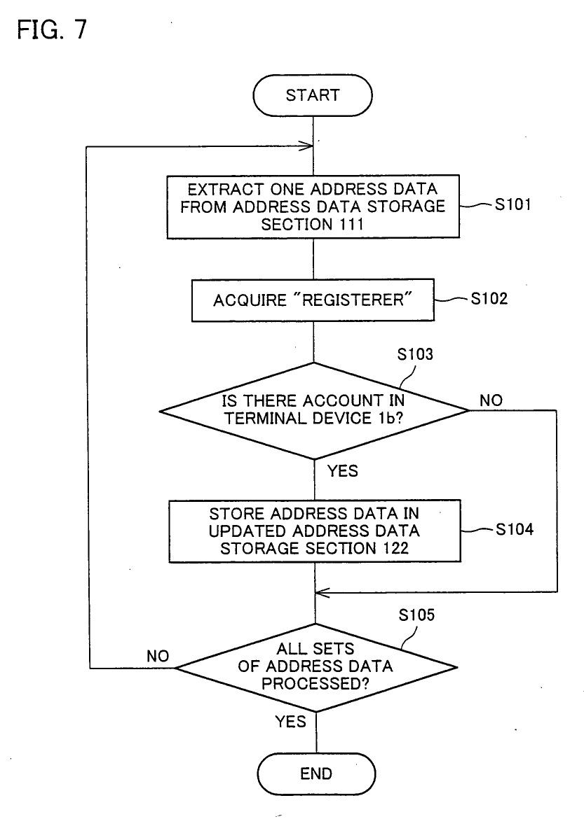

The following will describe details of the address data extraction process implemented by the account comparison section 115 under the control of the control section 118, with reference to a flowchart in FIG. 7.

As described previously, when the address data transmission and reception section 114 of the management server 100 receives sets of address data from each terminal device, and all the sets of address data are completely stored in the address data storage section 111, the control section 118 reads one set of address data from among the sets of address data temporarily stored in the address data storage section 111 in the procedure of the foregoing Step S24 (S101), and account information, for example, “registerer”, which is added to the one set of address data is acquired (S102). Then, using this “registerer”, comparison of the sets of account information of the respective terminal devices 1a and 1b (FIG. 5), stored in advance in the account management table 120, is carried out (S103).

In such a manner, it is determined whether the “registerer” (account information) is valid or invalid in the terminal device 1b. As seen from FIG. 5, for example, “Kenta Suzuki” who is one of the registerers of the sets of address data in FIG. 4 is granted a right for the use of the terminal device 1a, but he is not granted a right for the user of the terminal device 1b. Therefore, information about Kenta Suzuki, even if transmitted to the terminal device 1b, could not be viewed since Kenta Suzuki has no access right with respect to the terminal device 1b.

In the foregoing Step S103, address data of a registerer determined as valid in the terminal device 1b as well as the terminal device 1a among the “registerers” (sets of account information), is stored in the updated address data storage section 122 by the address data updating section 121 (S26 in FIG. 3). On the other hand, address data of a registerer determined as invalid in the terminal device 1b (“Kenta Suzuki” in FIG. 5) is not stored in the updated address data storage section 122 since this registerer is a user who does not have account information of the terminal device 1b (S104).

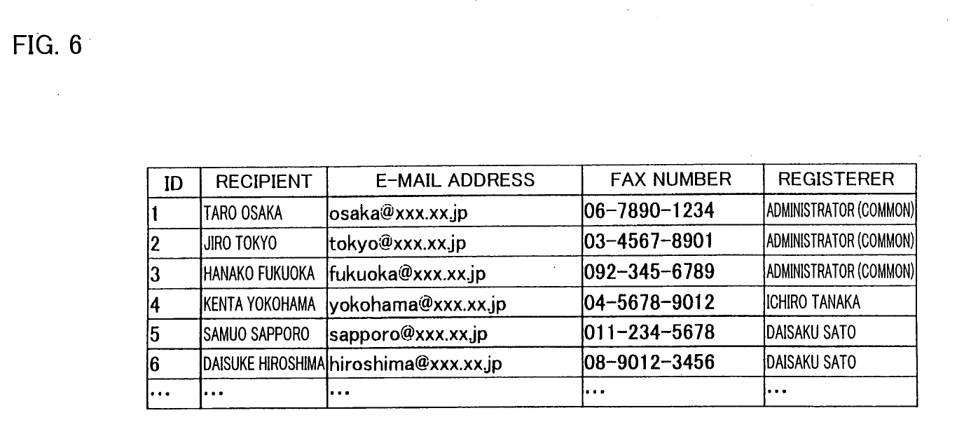

That is, as illustrated in FIG. 6, address data of the registerer “Kenta Suzuki” who has a right for the use of the terminal device 1a, but not a right for the use of the terminal device 1b, is not stored in the updated address data storage section 122. With this arrangement, address data (ID 7 in FIG. 4) that is used only by “Kenta Suzuki” who does not have the right for the use of the terminal device 1b (account information) is not registered in the terminal device 1b, so that leakage of information is prevented and the problem of a wasted storage space is solved.

Thereafter, as illustrated in FIG. 7, it is determined whether or not all the sets of address data stored in the address data storage section 111 have been subjected to the foregoing procedure. If it is determined that all the sets of address data have been subjected to the foregoing procedure, the process goes to Step S26. If there still remains any set of address data which has not been subjected to the foregoing procedure, the process goes back to the Step S101 (S105).

In the Step S105, if it is determined that all the sets of address data stored in the address data storage section 111 have been subjected to the foregoing procedure in the Steps S101 through S104, the address data transmission and reception section 114 transmits all sets of the address data stored in the updated address data storage section 122 (sets of address data illustrated in FIG. 6), to the address data transmission and reception section 14b of the terminal device 1b (S27). Upon receipt of the sets of address data illustrated in FIG. 6 by the address data transmission and reception section 14b, the control section 18b causes the address data storage section 11b to store the sets of address data.

Note that, a function of performing the foregoing Steps S25, S26, and S101 through S105 is one example of a function implemented by the terminal access right information extraction means of the present invention, and a function of performing the foregoing Step S27 is one example of a function implemented by the extracted information transmission means of the present invention.

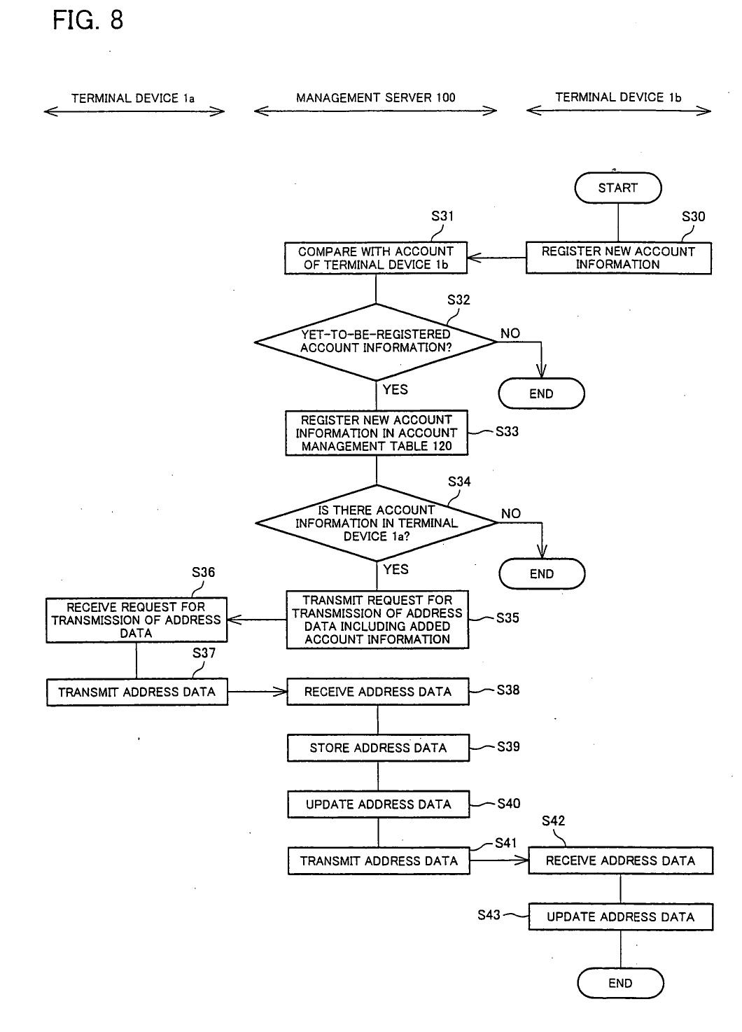

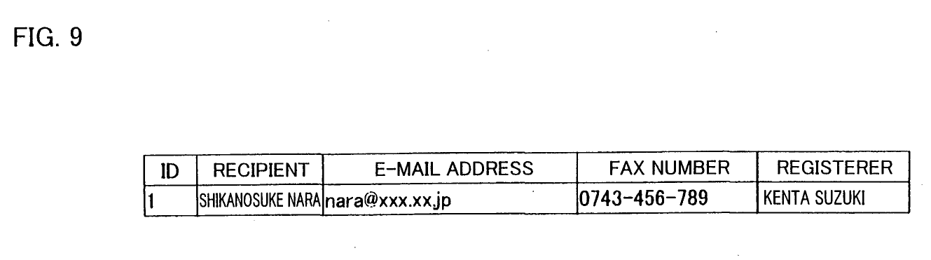

Next, referring to FIGS. 8 and 9, the following will describe a process for, when new account information is added to the terminal device 1b, automatically updating address data corresponding to the new account information of the terminal device 1b, in the terminal device 1a. Note that, S30, S31, and the like reference numerals given in the following descriptions represent procedures (steps) for this process.

When a program for addition of new account information is started periodically or by user's operation, the user registers new account information through the operation section 12b provided on the terminal device 1b (S30). Then, the new account information is transmitted from the terminal device 1b to the account comparison section 115 provided in the management server 100. The account comparison section 115 determines whether or not this account information has been already stored in the account management table 120 provided in the management server 100 (S31; see FIG. 5 for sets of account information of the terminal device 1b at this point in time).

If this account information is determined as yet-to-be-registered account information, it is additionally registered in the account management table 120. On the other hand, if this account information is determined as registered account information, this process is ended (S32). In the Step S32, if account information having been compared (hereinafter referred to as “new account information”) is determined as yet-to-be-registered account information, the control section 118 stores the new account information in the account management table 120 (S33). That is, for example, sets of account information of the terminal device, stored in the account management table 120, after addition of new account information “Kenta Suzuki”, are as shown in FIG. 5, Section (1).

Note that, the function of performing the foregoing Step S32 is one example of a function implemented by the new access right information determination means of the present invention, and the function of performing the foregoing Step S33 is one example of a function implemented by the terminal access right information writing means.

Also, it is determined whether or not a set of account information identical with the set of new account information exists in sets of account information of the terminal device 1a. That is, the account comparison section 115 determines whether or not a set of account information which is identical with the set of new account information exists in sets of account information of the terminal device 1a, illustrated in FIG. 5, Section (1) (S34). If it is determined that that there exists the identical account information, the process goes to Step S35. If it is determined that that there does not exist the identical account information, this process is ended.

In the Step S35, with respect to the terminal device 1a, a request for transmission of address data corresponding to the new account information is made. In this case, instead of making the request for transmission of address data corresponding to the new account information, a request for transmission of all sets of address data (i.e. all the sets of address data) may be made. In such a case, comparison of account information should be carried out in Steps S38 through S40, which will be described later.

A data signal regarding the request for transmission of address data, which has been transmitted from the management server 100, is received by the address data transmission and reception section 14a of the terminal device 1a (S36). Then, address data stored in the address data storage section 11a is transmitted from the address data transmission and reception section 14a to the management server 100 via the communication sections 17a and 117. In this case, for example, the transmitted address data is address data illustrated in FIG. 9 (S37).

The address data (see FIG. 9) having been transmitted from the terminal device 1a is received by the address data transmission and reception section 114 of the management server 100 (S38), and temporarily stored in the address data storage section 111 (S39). Thereafter, the address data stored in the address data storage section 111, which is address data corresponding to the new account information, is not subjected to the foregoing Step S25, is temporarily stored in the updated address data storage section 122 (S40), and is transmitted to the terminal device 1b (S41). Here, the foregoing Step S40 can be omitted.

Note that, a function of performing the foregoing Steps S38 through S41 is one example of a function implemented by the received information transmission means of the present invention.

In the terminal device 1b, the address data corresponding to the new account information, having been transmitted from the management server 100, is received by the address data transmission and reception section 14b (S42) and then stored in the address data storage section 11b (S43). That is, after addition of address data regarding “Kenta Suzuki” stored in the address data storage section 11a of the terminal device 1a, sets of address data stored in the address data storage section 11b of the terminal device 1b are as illustrated in FIG. 4.

Note that, in the present embodiment, at a timing when new account information is registered in the terminal device 1b, address data corresponding to the new account information is acquired from the terminal device 1a, and then, the acquired address data is reflected with respect to the terminal device 1b. Instead, the following process may be performed: at a timing when the terminal device 1b is used for the first time after account information is registered in the terminal device 1b, address data corresponding to the account information is acquired from the terminal device 1a, and the acquired address data is reflected with respect to the terminal device 1b.

In the present case, in the information processing system. A according to the present embodiment, the management server 100 only manages account information. However, the present invention may be an information processing system such that the management server 100 also manages address data in the same manner. This eliminates the management server 100 having to transmit address data to the terminal device 1a or the terminal device 1b, so that management of address data with consideration given to account information can be performed only by the management server 100. Further, the present invention may be an information processing system consisting of: a server which manages only address data, the management server 100 which manages account information, the terminal device 1a, and the terminal device 1b.

Further, as described below, without provision of the management server 100, which is one of the members of the information processing system A, transmission and reception of address data may be carried out directly between a plurality of terminal devices.

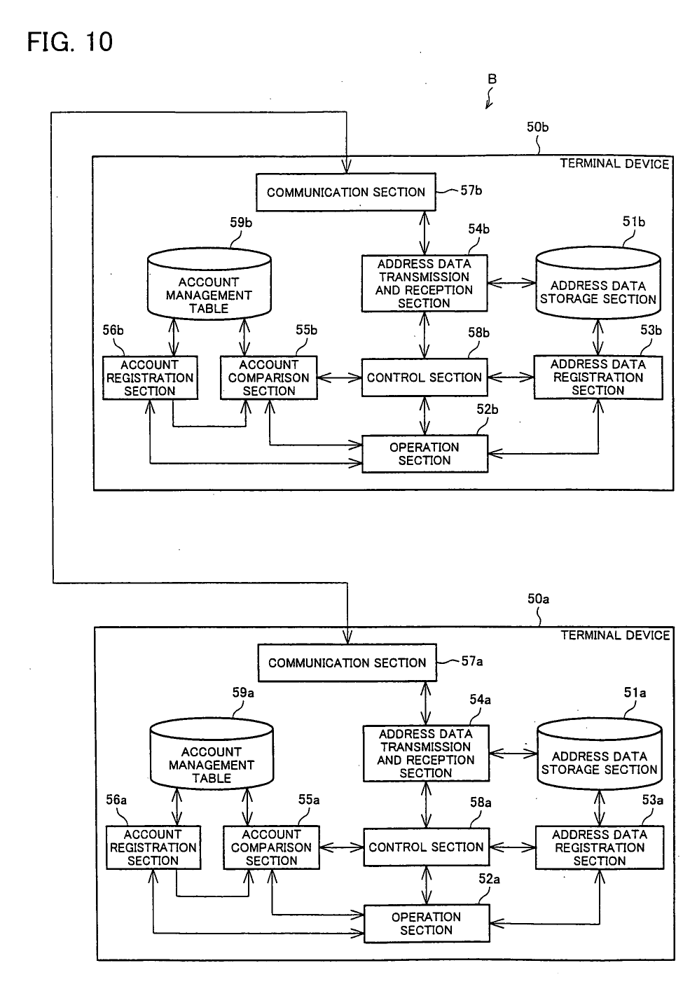

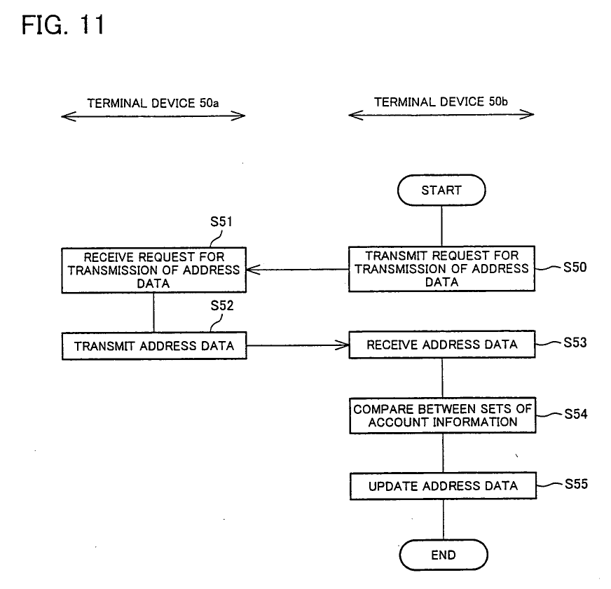

The following will describe an information processing system B according to another embodiment of the present invention with reference to FIG. 10 and FIG. 11. This information processing system B is a system in which without provision of the management server 100, which is one of the members of the foregoing information processing system A, transmission and reception of address data is carried out directly between a plurality of terminal devices 50 (terminal devices 50a, 50b, . . . ). In this case, sets of account information of the respective terminal devices 50 (terminal devices 50a, 50b, . . . ) are stored respectively in the terminal devices 50 (50a, 50b, . . . ) (e.g. account management tables 59a and 59b illustrated in FIG. 10).

As illustrated in FIG. 10, the information processing system B is composed of a plurality of terminal devices 50 (50a, 50b, . . . ) which are connected to each other via a network such as Internet or LAN. A communication interface of the information processing system B is the same as that of the foregoing information processing system A. Note that, in the present invention, although any terminal devices can update address data, the following will describe only updating of address data with respect to the terminal devices 50a and 50b. Further, an internal structure of the terminal device 50a is the same as that of the terminal device 50b. Therefore, only the internal structure of the terminal device 50a is described here, and description of the internal structure of the terminal device 50b is omitted.

Components 51a through 58a in the terminal device 50a in FIG. 10 are the same as the components 11a through 18a in the information processing system A illustrated in FIG. 1, so that descriptions thereof are omitted. In this embodiment, the terminal device 50a is provided with the account management table 59a which stores and manages account information of the terminal device 50a.

The following will describe a process of, in the information processing system B configured as illustrated in FIG. 10, reflecting address data stored in the address data storage section 51a of the terminal device 50a, with respect to an address data storage section 51b of the terminal device 50b with reference to FIG. 11. In this process, steps corresponding to the foregoing steps S25 and S26, which are performed by the management server 100 in the information processing system A, are performed by the terminal device 50b. Note that, S50, S51, and the like reference numerals given in the following descriptions represent procedures (steps) for the process.

In this process, for reflection of the address data stored in the terminal device 50a with respect to the terminal device 50b, it is first necessary to know differences between address data stored in the terminal device 50a and address data information in the terminal device 50b (terminal device except for the terminal device 50a). When the terminal device 50b starts a program for automatically reflecting address data stored in the terminal device 50a with respect to another terminal device, by itself or by user's operation, an address data transmission request signal is transmitted from an address data transmission and reception section 54b of the terminal device 50b to the terminal device 50a via communication sections 57b and 57a (S50).

When this address data transmission request signal is received by the address data transmission and reception section 54a of the terminal device 50a (S51), all the sets of address data stored in an address data storage section 51a are transmitted via the communication sections 57a and 57b to the address data transmission and reception section 54b (S52).

When all the sets of address data described above are received by the address data transmission and reception section 54b of the terminal device 50b (S53), an account comparison section 55b of the terminal device 50b compares sets of account information respectively added to all the sets of address data (e.g. “registerers” in FIG. 4) with sets of account information stored in the account management table 59b (see FIG. 5, Section (2)) (S54). With this arrangement, only a set of address data to be stored in the address data storage section 51b of the terminal device 50b can be selected from among all the sets of address data.

As a result of the foregoing Step S54, address data to which account information being valid in the terminal device 50b is added is stored in the address data storage section 51b by a control section 58b. Further, address data to which account information being invalid in the terminal device 50b is not stored in the address data storage section 51b (S55).

Note that, a function of performing the foregoing Step S55 is one example of a function implemented by the extracted information storage means of the present invention.

Further, in the present invention, the foregoing series of steps (Steps S1 through S13, Steps S20 through S29, Steps S30 through S43, Steps S50 through S55, and Steps S101 through S105) are realized respectively by control programs stored in the respective control sections 18a, 18b, and 118 (58a and 58b) of the information processing system A (or information processing system B).

Further, the information processing system B is arranged, as in the Step S54, such that the terminal device 50b determines, for itself, data that is valid in the terminal device 50b. Apart from this arrangement, it may be arranged such that the terminal device 50a having received a request for transmission of address data determines address data that is valid in the terminal device 50b, and transmits only valid address data to such an end. This arrangement more highly avoids the risk of information leakage.

Thus, to attain the above object, an information processing unit of the present invention is an information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device,
the sets of predetermined information stored in each of the terminal devices, being sets of information respectively having added thereto sets of access right information in whole or in part pertaining to an access right with respect to each of the terminal devices,
the information processing unit comprising:
(a) terminal access right information storage means which stores the sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

According to this arrangement, when one of the terminal devices on the network updates its sets of predetermined information (e.g. address data), the terminal access right information extraction means compares sets of access right information in whole or in part respectively added to the sets of predetermined information with sets of access right information in whole or in part about other terminal device, stored in the terminal access right information storage means, so as to extract a set of predetermined information having added thereto a set of access right information that both of the terminal devices have in common. Therefore, only such information is reflected with respect to other terminal device on the network.

That is, a set of predetermined information managed by a user who does not have the access right information is not extracted by the terminal access right information extraction means, and is not therefore reflected with respect to other terminal device on the network.

This prevents information of a user who does not have access right information (e.g. account information) to other terminal device from being unnecessarily registered in a plurality of terminal devices. As a result of this, the problem of information leaks is solved. Furthermore, only predetermined information of a user who has registered access right information is registered, so that the problem of a wasted storage space in the terminal device is solved.

Further, it is desirable that the foregoing information processing unit further includes:
(d) new access right information determination means which, upon receipt of a set of predetermined information having added thereto a set of new access right information from one of the terminal devices, determines whether or not a set of access right information identical with the set of new access right information is stored in the terminal access right information storage means;
(e) terminal access right information writing means which, if the new access right information determination means determines that the set of access right information identical with the set of new access right information is not stored, writes the set of new access right information into the terminal access right information storage means; and
(f) received information transmission means which receives a set of predetermined information from the other terminal device in accordance with the set of new access right information having been written by the terminal access right information writing means, and transmits the received set of predetermined information to the one of the terminal devices.

According to this arrangement, when the new access right information determination means determines that one terminal device has registered new access information (i.e. new account information), the access right information writing means writes the new access information into the terminal access right information storage means. Further, using received information transmission means, the predetermined information is acquired in accordance with the new access right information from other terminal device on the network and is reflected with respect to the terminal device in which the new access right information is registered. Therefore, it is not necessary to additionally perform a process for updating an address after addition of new account information. This brings the effect of saving the administrator's trouble.

Still further, under the condition where address data updating is carried out periodically by a control program or the like, predetermined information corresponding to new account information is registered before updating of address data. This can offer an environment in which the predetermined information corresponding to the new account information is ready for immediate use for a user having registered account information.

Note that, one example of the predetermined information includes address data. Further, one example of the access right information includes account information.

Further, the present invention can be arranged as a control program for controlling an information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device, when the sets of predetermined information stored in each of the terminal devices are sets of information respectively having added thereto sets of access right information in whole or in part pertaining to an access right with respect to each of the terminal devices, the control program causing the information processing unit to function as: (a) terminal access right information storage means which stores the sets of access right information about all users who can access the terminal devices; (b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto an access right that both of the terminal devices have in common; and (c) extracted information transmission means which transmits, to the other terminal device, the set of predetermined information having been extracted by the terminal access right information extraction means.

Still further, the present invention can be arranged as an information processing system, comprising: a plurality of terminal devices each storing sets of predetermined information; and an information processing unit which is intercommunicatively connected to the terminal devices, in which the information processing unit, when one of the terminal devices updates its sets of predetermined information, carries out predetermined communications with the terminal devices so as to reflect the updated sets of predetermined information with respect to sets of predetermined information stored in other terminal device, each of the terminal devices comprising: access right information addition means which adds, to each of the sets of predetermined information, access right information in whole or in part pertaining to an access right with respect to each of the terminal devices; the information processing unit comprising: (a) terminal access right information storage means which stores sets of access right information about all users who can access the terminal devices; (b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and (c) extracted information transmission means which transmits, to the other terminal device, the set of predetermined information having been extracted by the terminal access right information extraction means.

Yet further, it is desirable that the foregoing information processing system further includes: (d) new access right information determination means which, upon receipt of a set of new access right information from one of the terminal devices, determines whether or not a set of access right information identical with the set of new access right information is stored in the terminal access right information storage means; (e) terminal access right information writing means which, if the new access right information determination means determines that the set of access right information identical with the set of new access right information is not stored, writes the set of new access right information into the terminal access right information storage means; and (f) received information transmission means which receives a set of predetermined information from the other terminal device in accordance with the set of new access right information having been written by the terminal access right information writing means, and transmits the received set of predetermined information to the one of the terminal devices.

In this case, it is desirable that the terminal device further includes: predetermined information storage means which stores sets of predetermined information, and one of the sets of predetermined information is updated in such a manner that an attribute of the set of predetermined information to be updated is determined in accordance with the set of access right information in part which is stored in the terminal access right information storage means, and the set of predetermined information is stored in the predetermined information storage means in accordance with the attribute.

Note that, one example of the predetermined information includes address data. Further, one example of the access right information includes account information.

Further, the present invention may be arranged as a control program for controlling an information processing system, comprising: a plurality of terminal devices each storing sets of predetermined information; and an information processing unit which is intercommunicatively connected to the terminal devices, in which the information processing unit, when one of the terminal devices updates its sets of predetermined information, carries out predetermined communications with the terminal devices so as to reflect the updated sets of predetermined information with respect to sets of predetermined information stored in other terminal device, the control program causing each of the terminal devices to function as: access right information addition means which adds, to each of the sets of predetermined information, access right information in whole or in part pertaining to an access right with respect to each of the terminal devices, the control program causing the information processing unit to function as: (a) terminal access right information storage means which stores sets of access right information about all users who can access the terminal devices; (b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and (c) extracted information transmission means which transmits, to the other terminal device, the set of predetermined information having been extracted by the terminal access right information extraction means.

Still further, the present invention can be arranged as an information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device, each of the terminal devices comprising: (a) access right information addition means which adds, to each of the sets of predetermined information, access right information in whole or in part pertaining to an access right with respect to each of the terminal devices; (b) terminal access right information storage means which stores sets of access right information about all users who can access the terminal devices; (c) terminal access right information extraction means which, upon receipt of the updated sets of predetermined information from the one of the terminal devices, compares sets of access right information in whole or in part respectively added to the received sets of predetermined information, with the sets of access right information in whole or in part, stored in the terminal access right information storage means, so as to extract a set of predetermined information having added thereto an access right in part that both of the terminal devices have in common; and (d) extracted information storage means which stores the set of predetermined information having been extracted by the terminal access right information extraction means.

In this case, it is desirable that the access right information is account information and the predetermined information is address data.

Yet further, the present invention may be a control program for controlling an information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device, the control program causing each of the terminal devices to function as: (a) access right information addition means which adds, to each of the sets of predetermined information, access right information, in whole or in part pertaining to an access right with respect to each of the terminal devices; (b) terminal access right information storage means which stores sets of access right information about all users who can access the terminal devices; (c) terminal access right information extraction means which, upon receipt of the updated sets of predetermined information from the one of the terminal devices, compares sets of access right information in whole or in part added to the received sets of predetermined information, with the sets of access right information in whole or in part, stored in the terminal access right information storage means, so as to extract a set of predetermined information having added thereto an access right in part that both of the terminal devices have in common; and (d) extracted information storage means which stores the set of predetermined information having been extracted by the terminal access right information extraction means.

The components of the information processing unit and the terminal devices of the embodiment, as well as the process steps, may be implemented by controlling a keyboard or other input means, a display or other output means, or an interface circuit or other communication means with a CPU or other compute means executing computer programs recorded in ROM (Read Only Memory), RAM, or other storage means. Therefore, the various functions of the information processing unit and terminal devices of the present embodiment, as well as various process steps, are implemented by a computer equipped with the various means simply reading a storage medium containing the program for execution of the program.

In addition, the various functions and process steps in the information processing unit and the terminal devices are implemented on a given computer by recording the control program on a removable storage medium. The storage medium may be a memory (not shown) for process steps on a microcomputer. For example, the program medium may be something like a ROM. Alternatively, the program medium may be such that a program reader device (not shown) as an external storage device may be provided in which a storage medium is inserted for reading.

In addition, in any case, the stored program is preferably executable on access by a microprocessor. Further, it is preferred if the program is retrieved, and the retrieved program is downloaded to a program storage area in a microcomputer to execute the program. The download program is stored in a main body device in advance.

In addition, the program medium may be a storage medium constructed separably from a main body. The medium may be tape based, such as a magnetic tape or cassette tape; disc based, such as a flexible disc or hard disk including a magnetic disc and CD/MO/MD/DVD; card based, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, if the system is arranged to connect to the Internet or another communication network, the medium is preferably a storage medium which holds the program in a flowing manner so that the program can be downloaded over the communication network.

Further, if the program is downloaded over a communication network in this manner, it is preferred if the download program is either stored in a main body device in advance or installed from another storage medium.

Specific embodiments or examples implemented in the description of the embodiments only show technical features of the present invention and are not intended to limit the scope of the invention. Variations can be effected within the spirit of the present invention and the scope of the following claims.

1. An information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device,
the sets of predetermined information stored in each of the terminal devices, being sets of information respectively having added thereto sets of access right information in whole or in part pertaining to an access right with respect to each of the terminal devices,
the information processing unit comprising:
(a) terminal access right information storage means which stores the sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

2. The information processing unit according to claim 1, further comprising:
(d) new access right information determination means which, upon receipt of a set of predetermined information having added thereto a set of new access right information from one of the terminal devices, determines whether or not a set of access right information identical with the set of new access right information is stored in the terminal access right information storage means;
(e) terminal access right information writing means which, if the new access right information determination means determines that the set of access right information identical with the set of new access right information is not stored, writes the set of new access right information into the terminal access right information storage means; and
(f) received information transmission means which receives a set of predetermined information from the other terminal device in accordance with the set of new access right information having been written by the terminal access right information writing means, and transmits the received set of predetermined information to the one of the terminal devices.

3. The information processing unit according to claim 1, wherein:
the set of access right information is account information.

4. The information processing unit according to claim 1, wherein:
the set of predetermined information is address data.

5. A control program for controlling an information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device,
when the sets of predetermined information stored in each of the terminal devices are sets of information respectively having added thereto sets of access right information in whole or in part pertaining to an access right with respect to each of the terminal devices,
the control program causing the information processing unit to function as:
(a) terminal access right information storage means which stores the sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto an access right that both of the terminal devices have in common; and
(c) extracted information transmission means which transmits, to the other terminal device, the set of predetermined information having been extracted by the terminal access right information extraction means.

6. A computer-readable storage medium storing a control program for controlling an information processing unit which is intercommunicatively connected to a plurality of terminal devices each storing sets of predetermined information, and, when one of the terminal devices updates its sets of predetermined information, carries out predetermined communications with the terminal devices so as to reflect the updated sets of predetermined information with respect to sets of predetermined information stored in other terminal device,
when the sets of predetermined information stored in each of the terminal devices are sets of information respectively having added thereto sets of access right information in whole or in part pertaining to an access right with respect to each of the terminal devices,
the control program causing the information processing unit to function as:
(a) terminal access right information storage means which stores the sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto an access right that both of the terminal devices have in common; and
(c) extracted information transmission means which transmits, to the other terminal device, the set of predetermined information having been extracted by the terminal access right information extraction means.

7. An information processing system, comprising: a plurality of terminal devices each storing sets of predetermined information; and an information processing unit which is intercommunicatively connected to the terminal devices, in which the information processing unit, when one of the terminal devices updates its sets of predetermined information, carries out predetermined communications with the terminal devices so as to reflect the updated sets of predetermined information with respect to sets of predetermined information stored in other terminal device,
each of the terminal devices comprising:
access right information addition means which adds, to each of the sets of predetermined information, access right information in whole or in part pertaining to an access right with respect to each of the terminal devices;
the information processing unit comprising:
(a) terminal access right information storage means which stores sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

8. The information processing system according to claim 7, wherein:
the information processing unit further comprises:
(d) new access right information determination means which, upon receipt of a set of new access right information from one of the terminal devices, determines whether or not a set of access right information identical with the set of new access right information is stored in the terminal access right information storage means;
(e) terminal access right information writing means which, if the new access right information determination means determines that the set of access right information identical with the set of new access right information is not stored, writes the set of new access right information into the terminal access right information storage means; and
(f) received information transmission means which receives a set of predetermined information from the other terminal device in accordance with the set of new access right information having been written by the terminal access right information writing means, and transmits the received set of predetermined information to the one of the terminal devices.

9. The information processing system according to claim 7, wherein:
the terminal device further comprises: predetermined information storage means which stores sets of predetermined information, and one of the sets of predetermined information is updated in such a manner that an attribute of the set of predetermined information to be updated is determined in accordance with the set of access right information in part which is stored in the terminal access right information storage means, and the set of predetermined information is stored in the predetermined information storage means in accordance with the attribute.

10. The information processing system according to claim 7, wherein:
the set of access right information is account information.

11. The information processing system according to claim 7, wherein:
the set of predetermined information is address data.

12. A control program for controlling an information processing system, comprising: a plurality of terminal devices each storing sets of predetermined information; and an information processing unit which is intercommunicatively connected to the terminal devices, in which the information processing unit, when one of the terminal devices updates its sets of predetermined information, carries out predetermined communications with the terminal devices so as to reflect the updated sets of predetermined information with respect to sets of predetermined information stored in other terminal device,
the control program causing each of the terminal devices to function as:
access right information addition means which adds, to each of the sets of predetermined information, access right information in whole or in part pertaining to an access right with respect to each of the terminal devices,
the control program causing the information processing unit to function as:
(a) terminal access right information storage means which stores sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

13. A computer-readable storage medium storing a control program for controlling an information processing system, comprising: a plurality of terminal devices each storing sets of predetermined information; and an information processing unit which is intercommunicatively connected to the terminal devices, in which the information processing unit, when one of the terminal devices updates its sets of predetermined information, carries out predetermined communications with the terminal devices so as to reflect the updated sets of predetermined information with respect to sets of predetermined information stored in other terminal device,
the control program causing each of the terminal devices to function as:
access right information addition means which adds, to each of the sets of predetermined information, access right information in whole or in part pertaining to an access right with respect to each of the terminal devices,
the control program causing the information processing unit to function as:
(a) terminal access right information storage means which stores sets of access right information about all users who can access the terminal devices;
(b) terminal access right information extraction means which, upon receipt of the updated sets of predetermined information from the one of the terminal devices, compares sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(c) extracted information transmission means which transmits, to the other terminal device, the set of predetermined information having been extracted by the terminal access right information extraction means.

14. An information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device,
each of the terminal devices comprising:
(a) access right information addition means which adds, to each of the sets of predetermined information, access right information in whole or in part pertaining to an access right with respect to each of the terminal devices;
(b) terminal access right information storage means which stores sets of access right information about all users who can access the terminal devices;
(c) terminal access right information extraction means which, upon receipt of the updated sets of predetermined information from the one of the terminal devices, compares sets of access right information in whole or in part respectively added to the received sets of predetermined information, with the sets of access right information in whole or in part, stored in the terminal access right information storage means, so as to extract a set of predetermined information having added thereto an access right in part that both of the terminal devices have in common; and
(d) extracted information storage means which stores the set of predetermined information having been extracted by the terminal access right information extraction means.

15. The information processing system according to claim 14, wherein:
the set of access right information is account information.

16. The information processing system according to claim 14, wherein:
the set of predetermined information is address data.

17. A control program for controlling an information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device,
the control program causing each of the terminal devices to function as:
(a) access right information addition means which adds, to each of the sets of predetermined information, access right information, in whole or in part pertaining to an access right with respect to each of the terminal devices;
(b) terminal access right information storage means which stores sets of access right information about all users who can access the terminal devices;
(c) terminal access right information extraction means which, upon receipt of the updated sets of predetermined information from the one of the terminal devices, compares sets of access right information in whole or in part added to the received sets of predetermined information, with the sets of access right information in whole or in part, stored in the terminal access right information storage means, so as to extract a set of predetermined information having added thereto an access right in part that both of the terminal devices have in common; and
(d) extracted information storage means which stores the set of predetermined information having been extracted by the terminal access right information extraction means.

18. A computer-readable storage medium storing a control program for controlling an information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device,
the control program causing each of the terminal devices to function as:
(a) access right information addition means which adds, to each of the sets of predetermined information, access right information, in whole or in part pertaining to an access right with respect to each of the terminal devices;
(b) terminal access right information storage means which stores sets of access right information about all users who can access the terminal devices;
(c) terminal access right information extraction means which, upon receipt of the updated sets of predetermined information from the one of the terminal devices, compares sets of access right information in whole or in part added to the received sets of predetermined information, with the sets of access right information in whole or in part, stored in the terminal access right information storage means, so as to extract a set of predetermined information having added thereto an access right in part that both of the terminal devices have in common; and
(d) extracted information storage means which stores the set of predetermined information having been extracted by the terminal access right information extraction means.

19. An information processing method for an information processing unit which is intercommunicatively connected to a plurality of terminal devices each storing sets of predetermined information, when one of the terminal devices updates its sets of predetermined information, carrying out predetermined communications with the terminal devices so as to reflect the updated sets of predetermined information with respect to sets of predetermined information stored in other terminal device,
the sets of predetermined information stored in each of the terminal devices, being sets of information respectively having added thereto sets of access right information in whole or in part pertaining to an access right with respect to each of the terminal devices,
the method comprising the steps of:
(a) terminal access right information storage means of the information processing unit, storing the sets of access right information about all users who can access the terminal devices;
(b) terminal access right information extraction means of the information processing unit, upon receipt of the updated sets of predetermined information from the one of the terminal devices, comparing sets of access right information in whole or in part respectively added to the received sets of predetermined information, with the sets of access right information in whole or in part about the other terminal device, stored in the terminal access right information storage means, so as to extract, a set of predetermined information having added thereto a set of access right information that both of the terminal devices have in common; and
(c) extracted information transmission means of the information processing unit, transmitting, to the other terminal device, the set of predetermined information having been extracted by the terminal access right information extraction means.

20. An information processing method, which is implemented in an information processing system, comprising: a plurality of terminal devices each storing sets of predetermined information; and an information processing unit which is intercommunicatively connected to the terminal devices, for the information processing unit, when one of the terminal devices updates its sets of predetermined information, carrying out predetermined communications with the terminal devices so as to reflect the updated sets of predetermined information with respect to sets of predetermined information stored in other terminal device,
the method comprising the steps of:
(a) access right information addition means of the each of the terminal devices, adding, to each of the sets of predetermined information, access right information in whole or in part pertaining to an access right with respect to each of the terminal devices;
(b) terminal access right information storage means of the information processing unit, storing sets of access right information about all users who can access the terminal devices;
(c) terminal access right information extraction means of the information processing unit, upon receipt of the updated sets of predetermined information from the one of the terminal devices, comparing sets of access right information in whole or in part respectively added to the received sets of predetermined information, with the sets of access right information in whole or in part about the other terminal device, stored in the terminal access right information storage means, so as to extract a set of predetermined information having added thereto a set of access right information that both of the terminal devices have in common; and
(d) extracted information transmission means of the information processing unit, transmitting, to the other terminal device, the set of predetermined information having been extracted by the terminal access right information extraction means.

21. An information processing method, which is implemented in an information processing system, comprising: a plurality of terminal devices each storing sets of predetermined information and being connected to each other over a network, in which when one of the terminal devices updates its sets of predetermined information, predetermined communications are carried out between the terminal devices so as to reflect the updated sets of predetermined information with respect to sets of predetermined information stored in other terminal device,
the method comprising the steps of:
(a) access right information addition means provided in each of the terminal devices, adding, to each of the sets of predetermined information, access right information in whole or in part pertaining to an access right with respect to each of the terminal devices;
(b) terminal access right information storage means provided in each of the terminal devices, storing sets of access right information about all users who can access the terminal devices;
(c) terminal access right information extraction means provided in each of the terminal devices, upon receipt of the updated sets of predetermined information from the one of the terminal devices, comparing sets of access right information in whole or in part added to the received sets of predetermined information, with the sets of access right information in whole or in part, stored in the terminal access right information storage means, so as to extract a set of predetermined information having added thereto an access right in part that both of the terminal devices have in common; and
(d) extracted information storage means provided in each of the terminal devices, storing the set of predetermined information having been extracted by the terminal access right information extraction means.
